(19) United States
(12) Patent Application Publication
(10) Pub. No.: US 2002/0174024 A1
(43) Pub. Date: Nov. 21, 2002

(54) Process of marketing web design between web designers and authorizers through internet and supporting interface thereof

(76) Inventor: Chung-Yu Lin, Kaohsiung (TW)

Correspondence Address: David and Raymond Patent Group, 1050 Oakdale Lane, Arcadia, CA, 91006, US

(21) Appl. No.: 09/859,293

(22) Filed: May 16, 2001

(51) Int. Cl. G06F 17/60

(52) U.S. Cl. 705/26

(57) ABSTRACT

A process of marketing a web design includes the steps of (a) providing a service center a supporting interface wherein the service center has a web display zone for providing information of web designers and a profile thereof and a member zone for posting a respective website of the web designer through the supporting interface; (b) providing a member code for each of the web designers and a product code for the respective profile in the web display zone; and (c) sending a design order by an authorizer through the service center to the web designer, wherein the design order must include the member code and the product code selected from the web display zone. Therefore, the service center provides a fair deal between the web designers and the authorizers while being time effective.

### BACKGROUND OF THE PRESENT INVENTION

1. Field of Invention

The present invention relates to websites, and more particularly to a process of marketing web design between web designers and authorizers through Internet and supporting interface thereof.

2. Description of Related Arts

With the advent of the Internet, life has suddenly become much faster. Information, business, and conversation are just a click of a mouse away. Due to the development of Internet, electronic commerce becomes a new and alternative sale channel that enable people to advertise and sale their products through Internet. So, thousands of websites have been set up all around the world. However, each individual web designer mostly fails to maintain the income from authorizers and the expenditure of the website in balance so that most of the website end up in failure. Particularly, the web designers fail to build up a good connection to the authorizers.

There are several disadvantages for the web designers. The web designers must have basic skills and knowledge to design a website, such as “Photoshop”, “Illustrator”, “DeBablizer”, “Fusion”, Dream Waver”, “HotMetal Pro”, “Front page”, etc. For upgrading their skills, they have to learn “Windows NT”, “Unix”, “Perl”, “Java”, “C⁺⁺”, etc. However, the web designers cannot guarantee their stable revenue after taking lots of time and afford on those software.

Thus, the web designers are hard to find any channel to commutate with the authorizers. One method for the web designers is that they must walk in to the companies to sale their websites. However, such walk in method not only waste the web designers' time while they can work on the website but also has less chance to be success. Other method is placing an advertisement through the mass media such as newspaper, manginze, or E-mail. However, the expenditure of the web designers will be highly increased by such costly advertisements such that the cost of the authorizers will be proportionally increased in order balance the budget of the web designers.

In addition, after making the websites for the authorizers, the web designers must manage their financial credit such as invoice and tax. It is a headache for the web designers to handle all the unnecessary jobs which are not relate to their professional skills, so as to frustrate in an attempt to improve their skills.

Likewise, there are several disadvantages for the authorizers. The authorizers always have difficulties to find a right web designer to make their website. Since different web designers have different skills, the quality of the website may not be guaranteed to fit the need of the authorizer in such a manner that the authorizers may merely waste their money and time to make an unsatisfied website.

Moreover, since most authorizers do not have enough knowledge or background of the web design, there is a miscommunication between the authorizers and the web designers. Without an interface between the authorizers and the web designers, the authorizers may have argument with the web designers and may cost more money, time and afford to deal with the web designers.

Also, because of the various price range of the web design in the market, the web designers may only create the website only meet the requirement for the authorizers. The authorizers do not have any reference for requiring certain feathers in the website such that no additional feature will be added into the website.

### SUMMARY OF THE PRESENT INVENTION

A main object of the present invention is to provide a process of marketing web design between web designers and authorizers through Internet and supporting interface thereof, wherein a service center is provided to link all individual web designers from different regions through the supporting interface so that the authorizers can directly select a web design produced by the respective web designer while being cost effective. Therefore, the service center can enhance the transaction between the web designers and the authorizers so as to enhance the revenue for the web designers and ensure the quality of the web design for the authorizers. Thus, the service center only charges the commission of each transaction so as to balance the budget of the service center and further expansion.

Another object of the present invention is to provide a process of marketing web design between web designers and authorizers through Internet and supporting interface thereof, wherein the authorizers can select a suitable web design through the supporting interface while time effective. Thus, the selected web design will be posted in the member zone of the service center, which is a form of advertisement.

Another object of the present invention is to provide a process of marketing web design between web designers and authorizers through Internet and supporting interface thereof, wherein each of the individual web designers is considered as a form of small office home office (SOHO) such that the web designers can not only reduce the regular expenditure such as advertisement and office rental but also aggressively improve their skills and knowledge of web design, so as to proportionally increase their revenue.

Another object of the present invention is to provide a process of marketing web design between web designers and authorizers through Internet and supporting interface thereof, wherein the more selected website are accumulatively posted on the member zone, the more users especially authorizers will be enter into the service center. So, the service center not only acts as an interface between the web designers and the authorizers but also is an information center for users to research their related business.

Accordingly, in order to accomplish the above objects, the present invention provides a process of marketing web design between web designers and authorizers through Internet and supporting interface thereof, comprising the steps of:

(a) providing a service center having a predetermined domain name and a supporting interface wherein the service center comprises a web display zone for providing information of web designers and a member zone for posting a web design and a respective website of the web designer through the supporting interface;

(b) providing a member code for each of the registered web designers and a product code for the respective web design in the web display zone through the supporting interface; and

(c) sending a design order by an authorizer to the service center through the supporting interface, wherein the design order must include the member code and the product code selected from the web display zone.

### BRIEF DESCRIPTION OF THE DRAWINGS

FIG. 1 is a block diagram illustrating a process of marketing web design between web designers and authorizers through Internet and supporting interface thereof according to a preferred embodiment of the present invention.

FIG. 2 is a block diagram illustrating how the web designers involved in the process of marketing web design according to the above preferred embodiment of the present invention.

FIG. 3 is a block diagram illustrating how the authorizers involved in the process of marketing web design according to the above preferred embodiment of the present invention.

FIG. 4 is a block diagram illustrating the supporting interface involved in the process of the marketing web design according to the above preferred embodiment of the present invention.

### DETAILED DESCRIPTION OF THE PREFERRED EMBODIMENT

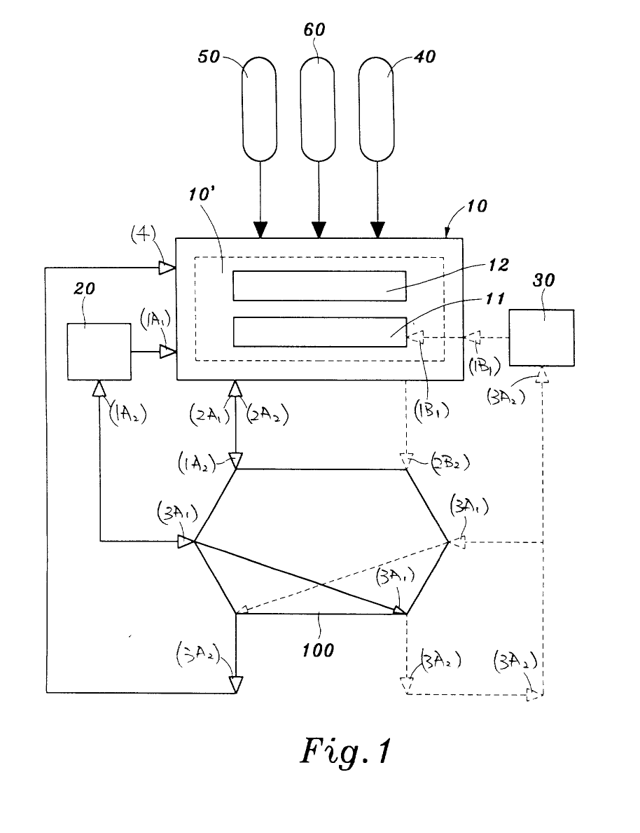

Referring to FIGS. 1 through 4, according to a preferred embodiment of the present invention, a process of marketing web design between web designers and authorizers through Internet and supporting interface thereof comprises the following steps.

(1) Provide a service center 10 having a predetermined domain name and a supporting interface 100 wherein the service center 10 comprises a web display zone 11 for providing information of web designers 20 who are registered and a member zone 12 for posting a web designer's profile and a respective website of the web designer 20 through the supporting interface 100.

(2) Provide a member code for each of the web designers 20 and a product code for the respective web design in the web display zone 11 through the supporting interface 100.

(3) Send a design order by an authorizer 30 to the service center 10 through the supporting interface 100, wherein the design order must include the member code and the product code selected from the web display zone 11.

The service center 10, which can be owned and operated by a web designer organization or an Internet service provider, can be an Internet website available for users to enter anytime wherein the supporting interface 100 of the service center 10 can network between the web designers 20 and the authorizers 30 for on-line marketing through Internet. The service center 10 should have full electronic and computer technical support, web support and web specialist for supporting and managing the service center 10.

The service center 10 further comprises a main page 10′ functioned as a directory for guiding the web designers 20 and the authorizers 30 to enter into the web display zone 11 and the member zone 12. In other words, the web designers 20 and the authorizers 30 start from the main page 10′ for selecting the destination. Thus, a help menu and a questionnaire should be provided in the main page 10′ of the service center 10 for guiding the web designers 20 and the authorizers 30 especially when they are the first time user.

The web display zone 11 of the service center 10 should contain all detail information of the web designers 20 such as the background of each web designer 20 and the respective profile so as to guide the authorizers 30 to select the preferred web designer 20 in the web display zone 11. The member zone 12 should contain all the websites designed by the respective web designers 20 which can not only show the authorizers 30 as a sample but also for advertising purpose.

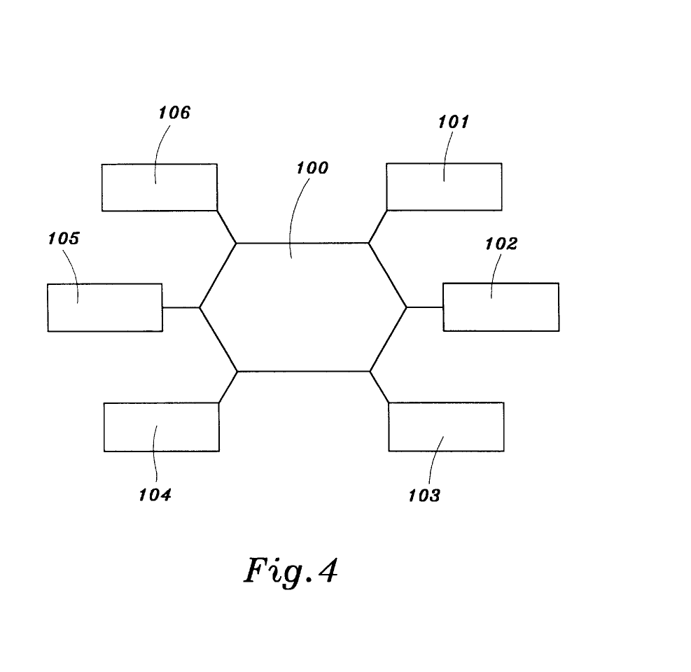

As shown in FIG. 4, in order to manage thousands information from both the web designers 20 and the authorizers 30 through the supporting interface 100, the supporting interface 100 has a first sub-interface 101 for managing personal profile of the web designers 20, a second sub-interface 102 for managing information of the web designer and the respective web design selected the authorizer 30, a third sub-interface 103 for matching the information between the web designer 20 and the authorizer 30, a fourth sub-interface 104 for managing a deal between the web designer 20 and the authorizer 30 and a commission from the deal, a fifth sub-interface 105 for maintaining an internal financial management including accounting, tax and management cost, and a sixth sub-interface 106 for managing an Internet connection of the service center 10 including the web display zone 11 and the member zone 12.

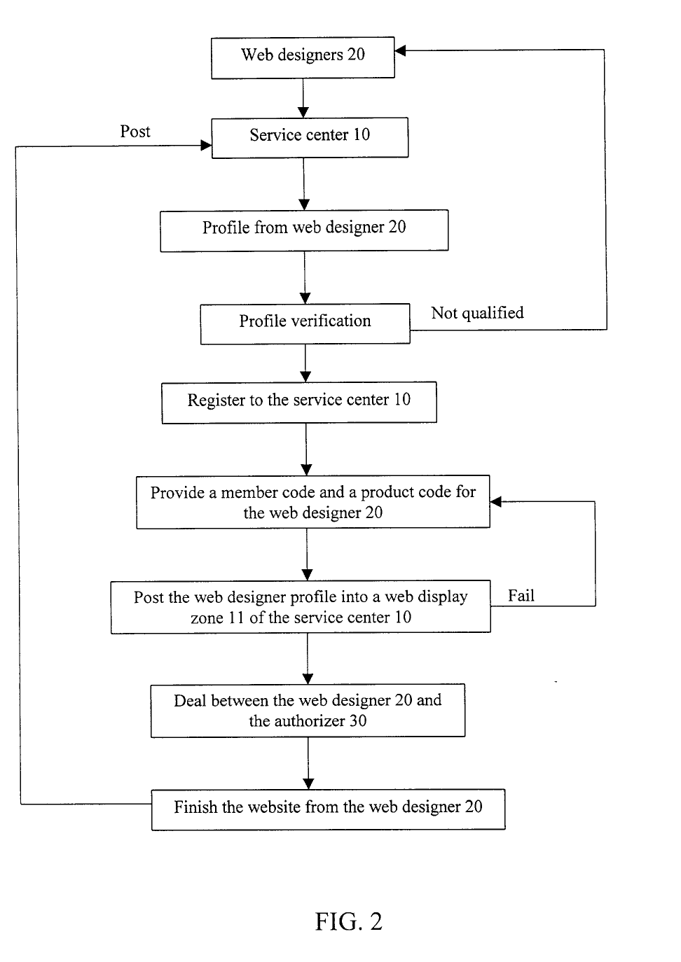

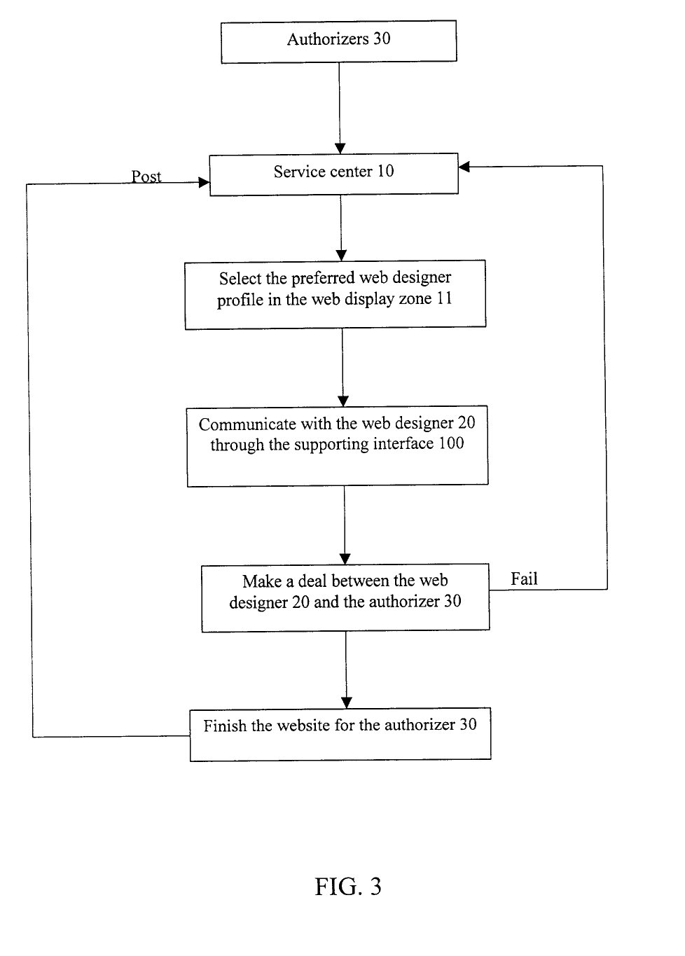

According to the preferred embodiment, the present invention for interfacing between the service center 10 and the web designer 20, as shown in FIGS. 2 and 3, in step (1), further comprises the steps of:

(1A₁) providing the main page 10′ of the service center 10 through the supporting interface 100; and

(1A₂) receiving a personal profile of the web designer 20 including contact information wherein the web designer 20 must submit a profile through the first sub-interface 101 of the supporting interface 100 for the service center 10 to verify.

In step (1A₂), when the profile of the web designer 20 is submitted to the service center 10 as an interview of the web designer 20, the web specialists of the service center 10 will verify the profile so as to determine the respective web designer 20 whether he or she has enough web skills for building the website for the authorizers 30.

For the web designer 20, in step (2), further comprises the steps of:

(2A₁) sending a notification to the web designer when the verification of the profile is qualified; and

(2A₂) providing the member code for each web designer 20 and the product code for the respective web design wherein both the member code and the product code are posted in the web display zone 11 through the second sub-interface 102 of the supporting interface 100 for the authorizers 30 to select.

After verifying the profile of the web designer 20, the web specialist will send the notification to the respective web designer 20 when he or she is qualified. The notification is a certification for official recognition that the web designer 20 has enough knowledge for designing the website. Then the web designer 20 who is qualified will be registered in the service center 10 and provided the member code for identification. The member code of the web designer 20 and the respective profile will be posted in the web display zone 11 to make an opportunity to be selected.

In step (2A₂), when the web designer 20 is disqualified and the web designed is rejected, the web designer 20 is adapted for further improving the skills and re-submit another profile in step (2A₁) in order to register to the service center 10 without time limitation.

For interfacing between the service center 10 and the authorizer 30, in step (2), the process further comprises the steps of:

(2B₁) receiving the member code and the product code selected by the authorizer 30 through the second sub-interface 102 of the supporting interface 100; and

(2B₂) receiving a personal profile of the authorizer 30 including contact information through the second sub-interface 102 of the supporting interface 100.

In step (2B₁), when the authorizer 30 selects the preferred web designer 20 and the respective profile in the web display zone 11, the corresponding member code and the product code are filled out in an electronic order form provided in the service center 10. Thus, the authorizer 30 must fill out he or her personal information such as phone number or e-mail address in the electronic order form in order to guide the service center 10 and/or web designer 20 to contact.

In step (3), further comprises the steps of:

(3A₁) sending the design order from the authorizer 30 to the web designer 20 through the second sub-interface 102 wherein the web designer 20 is adapted for contacting the authorizer 30 through the third sub-interface 103 of the supporting interface 100; and

(3A₂) dealing between the web designer 20 and the authorizer 30 including time schedule and price settlement through the fourth sub-interface 104 of the supporting interface 100.

Thus, in step (3A₁), the member code and the product code is selected by the authorizer 30 through the second sub-interface 102 of the supporting interface 100 wherein the web designer 20 is adapted for contacting with the authorizer 30 as an initial stage of the web designing. Accordingly, the web designer 20 should have a primary format or a general idea for the requirement of the authorizer 30 after the web designer 20 communicates with the authorizer 30.

In step (3A₂), after the initial stage, when the authorizer 30 decides to hire the web designer 20, the service center 10 functions as a middle man between the web designer 20 and the authorizer 30 for making a transaction therebetween such as a procedure, time required, and the cost of the website. The web specialist will review and finalize the website from the web designer 20 whether the website meets the requirement of the authorizer 30 and further technical arrangement so as to guarantee the quality of the website for the authorizer 30.

Thus, in each transaction, the service center 10 only charges a commission so as to balance the budget of the service center 10 and further expansion thereof. In other words, both web designers 20 and the authorizers 30 do not have to pay to the service center 10 constantly, such as membership fee or monthly fee, so as to reduce the unnecessary expenditure. Moreover, the web designers 20 can not only reduce the time and regular expenditure, such as advertisement and financial management, but also aggressively improve their skills and knowledge of web design, so as to proportionally increase their revenue.

When the profile of the web designer 20 selected by the authorizer 30 is refused to use in step (3A₁), the profile will be remained in the web display zone 11 for waiting next authorizer 30 to select. So, the profile will not be deleted from the web display zone 11 unless the web designer 20 authorizes to do so.

The process for marketing web design further comprises the step of:

(4) posting a website, which is the profile finished by the web designer, in both the web display zone 11 and the member zone 12 of the service center 10.

In step (4), after the web designer 20 build the website for the authorizer 30, the website will be posted in the member zone 12 of the service center 10 wherein the website will also posted in the web display zone 11 as the profile of the web designer 20 in such a manner that in each transaction, the web designer 20 will build up his or her stronger profile for encouraging another authorizers 30 to pick on again. Thus, the website posted on the member zone 12 will also be considered as a form of advertisement for the authorizer 30 for promotion.

Accordingly, the sixth sub-interface 106 of the supporting interface 100 also manage an Internet connection from other Internet users 40 to the service center 10, an entrance 50 of the service center 10 and a link from other websites 60, so as to securely connect to the service center 10 through any electronic communication media.

In accordance with the preferred embodiment of the present invention, the web designers 20 can stay at home and take the web project all over the world through the service center 10 without any regional boundary. Thus, both web designers 20 and authorizers 30 can save up to 80% of regular expenditure and cost due to the financial and personnel management. Thus, the service center 10 provides a fair deal between the web designers 20 and the authorizers 30 while being time effective. Anyone can be famous and a top web designer while the web designer gradually builds up his or her strength through aggressively improvement by practice from the service center 10.

While the foregoing description describe the preferred embodiment of the present invention, it should be appreciated that certain obvious modifications, variations, and substitutions may be made without departing from the spirit and scope of the present invention. The steps need not be preformed exactly in the order as outlined above nor are all the steps delineated above necessary for practicing the present invention.

What is claimed is:

1. A process of marketing web design, comprising the steps of:
(a) providing a service center having a predetermined domain name and a supporting interface wherein said service center comprises a web display zone for providing information of web designers and a profile thereof and a member zone for posting a respective website of said web designer through said supporting interface;
(b) providing a member code for each of said web designers and a product code for said respective profile in said web display zone through said supporting interface; and
(c) sending a design order by an authorizer through said service center to said web designer, wherein said design order must include said member code and said product code selected from said web display zone.

2. The process, as recited in claim 1, for said web designer, in step (a), further comprising the steps of:
providing a main page of said service center through said supporting interface;
receiving a personal profile of said web designer including contact information wherein said web designer must submit said profile through said supporting interface for said service center for verification;
sending a notification to said web designer when said verification of said profile is qualified so as to register said web designer in said service center; and
providing said member code for each said web designer who is registered.

3. The process, as recited in claim 1, for authorizer, further comprising the steps of:
receiving said member code and said product code selected by said authorizer through said supporting interface;
receiving a personal profile of said authorizer including contact information; and
dealing between said web designer and said authorizer including time schedule and price settlement through said supporting interface.

4. The process, as recited in claim 2, for authorizer, further comprising the steps of:
receiving said member code and said product code selected by said authorizer through said supporting interface;
receiving a personal profile of said authorizer including contact information; and
dealing between said web designer and said authorizer including time schedule and price settlement through said supporting interface.

5. The process, as recited in claim 1, further comprising a step of:
(d) posting a website, which is said profile finished by said web designer, in both said web display zone and said member zone of said service center.

6. The process, as recited in claim 2, further comprising a step of:
(d) posting a website, which is said profile finished by said web designer, in both said web display zone and said member zone of said service center.

7. The process, as recited in claim 3, further comprising a step of:
(d) posting a website, which is said profile finished by said web designer, in both said web display zone and said member zone of said service center.

8. The process, as recited in claim 4, further comprising a step of:
(d) posting a website, which is said profile finished by said web designer, in both said web display zone and said member zone of said service center.

9. The process, as recited in claim 4, wherein said service center charges a commission of each transaction between said web designer and said authorizer so as to balance a budget of said service center and further expansion.

10. The process, as recited in claim 8, wherein said service center charges a commission of each transaction between said web designer and said authorizer so as to balance a budget of said service center and further expansion.

11. The process, as recited in claim 4, wherein said supporting interface comprises a first sub-interface for managing said personal profile of said web designers and said authorizers, wherein said profile is submitted by said web designer through said first sub-interface of said supporting interface.

12. The process, as recited in claim 8, wherein said supporting interface comprises a first sub-interface for managing said personal profile of said web designers and said authorizers, wherein said profile is submitted by said web designer through said first sub-interface of said supporting interface.

13. The process, as recited in claim 4, wherein said supporting interface further comprises a second sub-interface for managing information of said web designer and said respective web design selected said authorizer, wherein said design order from said authorizer is sent to said service center through said second sub-interface of said supporting interface.

14. The process, as recited in claim 8, wherein said supporting interface further comprises a second sub-interface for managing information of said web designer and said respective web design selected said authorizer, wherein said design order from said authorizer is sent to said service c enter through said second sub-interface of said supporting interface.

15. The process, as recited in claim 4, wherein said supporting interface further comprises a third sub-interface for managing said information between said web designers and said authorizers, wherein after sending said order to said web designer, said web designer is adapted for contacting said respective authorizer through said third sub-interface of said supporting interface.

16. The process, as recited in claim 8, wherein said supporting interface further comprises a third sub-interface for managing said information between said web designers and said authorizers, wherein after sending said order to said web designer, said web designer is adapted for contacting said respective authorizer through said third sub-interface of said supporting interface.

17. The process, as recited in claim 4, wherein said supporting interface further comprises a fourth sub-interface for managing a deal between said web designer and said authorizer and a commission from said deal, wherein time schedule and price settlement are managed through said fourth sub-interface of said supporting interface.

18. The process, as recited in claim 8, wherein said supporting interface further comprises a fourth sub-interface for managing a deal between said web designer and said authorizer and a commission from said deal, wherein time schedule and price settlement are managed through said fourth sub-interface of said supporting interface.

19. The process, as recited in claim 4, wherein said supporting interface further comprises a fifth sub-interface for maintaining an internal financial management including accounting, tax and management cost, and a sixth sub-interface for managing an internet connection of said service center 10 including said web display zone and said member zone.

20. The process, as recited in claim 8, wherein said supporting interface further comprises a fifth sub-interface for maintaining an internal financial management including accounting, tax and management cost, and a sixth sub-interface for managing an internet connection of said service center 10 including said web display zone and said member zone.
